(19) United States
(12) Patent Application Publication
(10) Pub. No.: US 2013/0255951 A1
(43) Pub. Date: Oct. 3, 2013

(54) Compositions, Systems and Methods for Releasing Additive Components

(71) Applicants: David Alan Little, Newtown, PA (US); Magesh Sundaram, Chicago, IL (US)

(72) Inventors: David Alan Little, Newtown, PA (US); Magesh Sundaram, Chicago, IL (US)

(73) Assignee: DOBER CHEMICAL CORPORATION, Woodridge, IL (US)

(21) Appl. No.: 13/770,531

(22) Filed: Feb. 19, 2013

Related U.S. Application Data
(60) Provisional application No. 61/686,100, filed on Mar. 30, 2012.

(51) Int. Cl. C09K 8/70; B05D 7/24; B29C 43/02; E21B 43/26

(52) U.S. Cl. CPC C09K 8/706; E21B 43/26; B05D 7/24; B29C 43/02
USPC 166/305.1; 507/219; 427/213; 264/129

(57) ABSTRACT

Compositions, systems and methods for the controlled and/or delayed release of chemical additive components into an aqueous fluid used in hydraulic fracturing of oil and/or gas wells. The chemical additive components may include a viscosity-reducing composition, an oxidizer composition, a pH modulating composition, a lubricant composition, a cross-linking composition, an anti-corrosion composition, an biocide composition, a crosslink-enhancing composition, and/or a combination of two or more of these compositions. Further embodiments include additives and methods of delivering a particle comprising an additive component to a desired site in an aqueous medium prior to release of the additive component into the aqueous medium. The coating is permeable, but insoluble in an aqueous medium, whereupon the additive components are released into the medium.

This application claims priority pursuant to 35 U.S.C. §119(e) to provisional patent application 61/686,100, which was filed Mar. 30, 2013 and is hereby incorporated by reference herein in its entirety.

### INVENTION AND BACKGROUND

The present invention relates to systems, compositions, and methods involved in the extraction of petroleum, natural gas, coal seam gas, and other substances from wells. In particular, the invention relates to additives used in hydraulic fracturing for the extraction of substances, primarily hydrocarbons, from an underground rock layer.

Hydraulic fracturing, or “fracking” refers to the induction of fractures in underground rock layers by pumping a pressurized fluid within the well in order to cause fracturing of the rock layer in which the substances to be extracted are located. Although also useful for the extraction of other substances, hydraulic fracturing is of particular importance in the extraction of petroleum and natural gas for energy uses. This technology permits the extraction of substantial amounts of hydrocarbons from previously exploited oil and gas wells, thereby enhancing the yield of hydrocarbons from such wells, many of which were formerly considered to have been exhausted.

The vast natural gas reservoirs worldwide, particularly in North America, combined with the efficiency of hydraulic fracturing techniques, has led many experts to consider that natural gas will account for over 25% of world energy demand by 2035. Fracking techniques permit the extraction of large amounts of formerly inaccessible hydrocarbons. The United States, which has a technological and legal advantage over much of the world, is predicted to become the world's largest oil producer within the next 15 to 20 years due to large-scale use of hydraulic fracturing techniques.

Hydraulic fracturing comprises pumping large volumes of water, slurried with sand or another rigid agent or “proppant”, into a wellbore under high pressure. The water and proppant are combined in a “hydraulic fracturing fluid” or “fracking fluid” which contains additional chemicals having a variety of purposes. The subterranean formations in which the hydraulic fracturing fluid is pumped our natural reservoirs typically porous sandstones, limestones, dolomite rocks or shale rock or coal beds. Hydraulic fracturing permits gas and oil to be extracted from rock formations existing at depths from about 5002 about 20,000 feet. At this depth the porosity of the rock or pressure under which the reservoir is subjected may not be great enough to permit a natural flow of gas and oil from the rock at rates high enough to make its extraction economical. The introduction of fractures in the rock can increase the flow of oil and gas and the overall production of oil and gas from the reservoir rock.

Fractures are created by pumping the fracturing fluid into the well bore at a rate sufficient to increase the pressure within the well to exceed that of the fracture gradient of the rock. When the rock cracks, the proppant within the fracturing fluid keeps the crack open, and extends the crack still farther. The chemical additives are generally chosen for each well and geological formation to optimize the extraction of the gas or oil. For example, acid can be added to scour the perforations made in the rock; a gelling agent such as guar gum helps keep the sand or other granular agent (called a “proppant”) in suspension. Usually later in the process, viscosity reducing agents such as oxidizers and/or enzyme breakers are sometimes added to encourage the flow of hydrocarbons from the fracture site, or to break up the gelling agents and permit the induction of flow.

A typical aqueous hydraulic fracturing fluid comprises about 99.5% to about 90% (by weight) water and proppant, with the remainder of the mass (from about 10% to about 0.5% by weight) being chemicals. Various additives may be in liquid or solid form; additionally, the chemicals and additives disclosed below are examples of chemical agents that may perform the indicated function, and are not intended as an exhaustive list. Those of ordinary skill in the art are well aware of additional or alternative agents to those listed to serve these functions. Moreover, each and every of the indicated functions below may not be required to be used in each, or even any, specific instance.

Proppant:

Used to assist in causing and extending fractures, and maintaining fractures open once formed. Examples of proppants include, but are not limited to, nut shells, plastic beads, glass beads, sand, sintered alumina, urea prills and aluminum spacers.

Acid:

An acid helps dissolve minerals and initiate the fissure in the rock; such acids may comprise, for example, HCl at a concentration of about 0.12% by weight.

Biocide:

A biocide is often added to prevent the growth of bacteria in the water, and thus fouling in the pipe. Various biocides may be used, and their concentration depends upon the specific biocide used; for example, glutaraldehyde may be used as a biocide at a concentration of about 0.001% by weight.

Sodium Chloride:

Sodium chloride permits a delayed breakdown of gel polymer chains, and may be included at a concentration of about 0.1% by weight.

Corrosion Inhibitor:

A corrosion inhibitor may be used to prevent corrosion of the pipe; the coated APS particles of the present invention may provide corrosion inhibiting activity; additional corrosion inhibitors may also be provided, such as N,N-dimethyl formamide at a concentration of about 0.002% by weight.

“Breaker” Chemicals:

“Breakers” are oxidizing agents, enzymes, and/or other chemical agents that facilitate the process of degrading the viscosity enhancing agents of the fracking fluid and thereby decrease the fluid's viscosity when flowback of the gas or oil from fractured rock is desired. Breaker chemicals may include, for example, ammonium persulfate, sodium persulfate, potassium persulfate, sodium chlorite, ammonium bifluoride, ammonium fluoride, sodium fluoride, potassium fluoride, sulfamic acid, citric acid, oxalic acid, ammonium sulfate, sodium acetate and enzymes and mixtures of any two or more of these.

Borate:

Borate salts, which may be used at a concentration of about 0.007% by weight, maintains fluid viscosity as the temperature of the aqueous hydraulic fluid increases partially by promoting the formation of crosslinking between the chains or fibers of gelling agents. This is desirable in order to maintain the solid components of the hydraulic fluid in suspension as the fluid flows into the rock formation.

Lubricants:

Polyacrylamide and petroleum distillates may prevent or minimize friction between fluid and pipe; either or both of these agents may be present at, for example, a combined concentration of about 0.09% by weight.

Gelling Agents:

Gelling agents also help maintain the sand and chemical particles of the present invention in suspension within the fracking fluid. Such agents may include, without limitation, guar gum and/or hydroxyethyl cellulose, which thicken the water to help suspend the sand and particles.

Citric Acid:

Citric acid may be present, for example at a concentration of about 0.004% by weight, are to help prevent precipitation of metal oxides from solution.

Potassium Chloride:

Potassium chloride may be present at a concentration of about 0.6% by weight creates a brine carrier fluid.

Carbonates:

Sodium and/or potassium carbonate, which also may be present, maintain the effectiveness of cross linkers.

Alkyl Glycols:

Ethylene glycol and/or polyethylene glycols may also be added to prevent the deposition or formation of scale in the pipe. Solid scale inhibitor forms may alternatively or additionally be present.

Viscosity Enhacing Agent:

Isopropyl, for example, at a concentration of about 0.085% by weight may be added as a thickening agent.

As mentioned above, those of skill in the art are aware that this is a single example of one “typical” hydraulic fracturing fluid, and many variations, additions, and omissions can and should be made to such hydraulic fluids while maintaining the same essential properties to tailor the fluid to the particular oil or gas well conditions to be encountered.

Fracking operations may employ as much as 1,000,000 to 3,000,000 gallons of water or more. The water is generally transported to the site of operations in water trucks. A high-pressure pump, such as a pumper truck, injects the slurry of proppant, chemicals (which may include chemicals in particulate form) and water into the well, as far as 20,000 feet below the surface. The pressurized fluid mixture causes the rock layer to crack. The fissures are maintained open by the sand and/or other proppant so that oil and/or natural gas can flow out of the fissures through the well casing, and be collected from the top of the well.

Depending upon the requirements of the specific fracking operation, and the purpose(s) and class of chemical used, it may be desirable or useful for the chemical to be provided in a delayed or controlled release particle. For example, if the chemical is particularly active, it may exert its activity with greater potency than is required or needed at the well site. For example, the viscosity of the hydraulic fracturing fluid may be very quickly reduced, thereby failing to properly maintain the proppant in suspension. Furthermore, if the chemical agent is a reagent (rather than a catalyst) then the bulk of the chemical may be reacted early in the hydraulic fracturing process, and may not fully penetrate within the well fractures, particularly at depths where the chemicals activity may be particularly desired or required.

To overcome this problem various means can be used to deliver the active chemical to a depth, or proximal to a specific geological structure as desired. For example, a chemical having a particular activity may be substituted with another chemical having similar activity, but with a reduced reactivity or rate of reaction as compared to the first chemical. Additionally, or alternatively, the chemical may be formulated to be comprised in a particle or pellet that is suspended in the fracking fluid. The particulate nature of the fracking additive means that there will be a reduced amount of affidavit in contact with the fracking fluid directly as compared to, for example, a powdered or liquid additive. If the additive is slowly soluble in water, the inside of the particle will become exposed to the fracturing fluid when the outside of the particle has dissolved. This means that the particle will have travelled farther within the wellbore or fracture when it is solubilised or dispersed and the chemical will thus maintain its activity further within the well.

In other embodiments, the additive may be either largely soluble, or soluble in aggregates which disperse from the particle quickly and immediately exert their activity. For example, breaker additives start to degrade the viscosity enhancer in the fracturing fluid upon contact thereby lowering the efficiency of the fracturing process. In such cases, additional time and labor are needed to effect the reduction of the viscosity of fracturing fluids introduced into the subterranean formation. The use of organic breakers such as alkyl formate may alleviate this problem, since they can be applied along with the fracturing fluid. But these types of breakers rely on certain subterranean conditions, such as elevated temperature and time, to effect a viscosity reduction of the fracturing fluid. Since these organic breaker chemicals work on chemical change, such as hydrolysis, they are slow in effecting viscosity reduction. Furthermore, their performance can be unpredictable.

Water-soluble particulate solid chemicals encapsulated with coatings of polymers and the like have been utilized heretofore. The encapsulating coatings on the water-soluble chemicals have been utilized to control the times when the chemicals are released in aqueous fluids. For example, encapsulated particulate solid chemicals have been used in oil and gas well treating fluids such as hydraulic cement slurries, formation fracturing fluids, formation acidizing fluids and the like.

Thus, coated particles have been proposed or used to delay or control the rate of release of fracking fluid additives, including breakers. For example, U.S. Pat. No. 5,102,558 to McDougall et al. discusses coating breaker chemicals (themselves coated onto a seed “substrate” such as urea) with a neutralized sulfonated elastomeric polymer. These seal the breaker from the fracking fluid; the coating is slowly permeable to water and essentially impermeable to the breaker chemicals under well-bore conditions. Upon introduction into aqueous fracturing fluids or other aqueous wellbore fluids, the encapsulated particle slowly absorbs water by diffusion through the polymeric coating. This water dissolves the breaker substrate and sets up an osmotic gradient that in turn draws in more water. Pressure builds up inside the particle, and it expands until resealable micropores form in its walls. Concentrated substrate solution is then ejected through the micropores into the surrounding medium. This relives the pressure inside the capsule that then shrinks. The micropores reseal, and the process repeats itself until insufficient substrate remains for swelling and micropores to form.

Reddy et al., U.S. Pat. No. 5,373,901 disclose methods of making encapsulated chemicals for use in controlled time-release applications in hydraulic fracturing operations. In these methods, a coating comprising a dry hydrophobic film forming material or a dry sparingly soluble material and particulate silica, is formed on the particulate solid chemical. The hydrophobic material or the sparingly soluble material is present in this coating in an amount such that it provides a dry shield on the encapsulated chemical and preferably provides a short delay in the release of the encapsulated chemical in the presence of water.

Reddy et al., U.S. Pat. No. 6,444,316 disclose methods of making encapsulated chemicals for use in controlled time-release applications. In these methods, a first coating, is substantially similar to the coating of the '901 patent. A second, outer coating comprising a porous cross-linked hydrophilic polymer is next formed on the first coating. The porous hydrophilic polymer is present in the second coating in an amount such that when contacted with water it prevents the substantial dissolution of the encapsulated chemical for a selected time period.

However, particles depend upon “the presence of silica in the [outer] coating composition [aids] . . . in introducing imperfections in the dry coating to facilitate the controlled release of the encapsulated chemical.” See e.g., '316 patent. In this system the size of the holes or imperfections created by the silica in the dry layer may be highly variable, and thus the controlled release itself of chemicals from the particle may be variable and depend not only on chemical factors, but on the presence, absence, or amount of mechanical shear forces due to collapse or closure of fractured rock formations.

Thus, there remains a need for encapsulated or coated particles of chemical additives for hydraulic fracturing applications that are formulated to release the chemical additive at a substantially constant rate over a time period of greater than about one hour, or greater than about two hours, or greater than about three hours, or greater than about 4 hours, or greater than about 5 hours, or greater than about 6 hours or more under conditions of heat and pressure encountered within an underground well, such as an oil or gas well, during hydraulic fracturing operations.

### SUMMARY OF THE INVENTION

The present invention relates to methods and compositions for controllably breaking, or reducing the viscosity of, and aqueous based hydraulic fracturing fluid used in stimulating the release of, for example, hydrocarbons and natural gas from underground rock formations. In particular, the invention is related to methods and compositions involving encapsulating chemicals, such as viscosity reducing chemicals, to slow their release in hydraulic fracturing operations. Briefly, the encapsulated chemicals are enclosed within a water insoluble shell, coating, or membrane that is permeable to at least one component of a hydraulic fracturing fluid during use in hydraulic fracturing operations. The permeability of the coating of the particle is chosen, designed, or otherwise made to slow the diffusion of the fluid component into the coated particle, and/or to slow the diffusion of the dissolved or dispersed chemical from the coated particle into the surrounding fluid so as to prevent the chemical additive from exerting its activity immediately upon its addition to the hydraulic fracturing fluid.

Thus, the present invention is related to methods of slowly releasing amounts of a chemical additive over time, instead of a single release of the chemical, from an encapsulated breaker. The coating or membrane which surrounds the encapsulated chemical additive (hereinafter sometimes referred to as “additives in particulate form, or “APF particles”) remains intact in an aqueous-based fluid at temperatures encountered in hydraulic fracturing operations; for example, from about 60° F. to about 300° F., and at a fluid pH of about 12 or less, without premature release of the chemical into the fluid.

The present invention provides compositions, methods of making, and methods of using APF particles in hydraulic fracturing applications. In particular, the invention is drawn to a coated APF particle comprising a water-dispersible or water-soluble chemical additive encapsulated by a water-insoluble coating comprising a blend of a polymer component and a wax component. The coating comprising the polymeric component and the wax component shall be referred to herein as the “PW coating”. The polymeric component of the PW coating forms a porous film on the outside surface of the chemical additive particle; the wax component of the PW coating is preferably substantially not (or is not) cross-linked to the polymeric component of the PW coating.

Although not wishing to be limited by theory, the Applicants believe that the wax portion of the PW coating acts to limit the release area of the coating, thereby reducing the rate of release of a water-soluble or water-dispersible chemical within the APF particle when immersed in an aqueous fluid, such as an aqueous hydraulic fracturing fluid.

In preferred embodiments, the PW coating comprises a blend of the polymeric component and the wax component that is dispersed in a solvent before being used to coat the outside surface of the APF particle. Preferably the wax component is used at a lesser concentration then is the polymeric component. For example, the ratio of the wax component to the polymeric component may be varied to configure the APF particle to release the chemical additive at different rates and at different temperatures. In particular embodiments, the ratio of the wax component and the polymeric component is about 0.013; this ratio may be varied as required or desired to provide PW coated APF particles having a desired release rate under actual conditions existing within a given oil or gas well. Thus, when a greater release rate is required or desired, the concentration of the wax component may be decreased. Similarly, if a slower rate of release is desired or required, the concentration of the wax component may be increased.

The PW coating of the present invention thus provides high degree of flexibility in formulating specific, tailored controlled-release PW coated APF particles to release the chemical additives at a desired rate of release into an aqueous fluid system. Depending upon factors including the solubility or dispersibility of the chemical additive in an aqueous solvent, the temperature of the aqueous fluid system in which the chemical additive particles are suspended, the operating pressure, and other factors, the rate of release of the chemical additive within a PW-coated APF particle may be controlled to a high degree.

In preferred embodiments, the PW coated APF particles of the present invention contain chemical additives useful in hydraulic fracturing applications. The chemical additives are preferably in solid form at room temperature, although in less preferred embodiments the chemical additives may be in liquid form and frozen, coordinated, used to impregnate a seed particle (such as urea) or otherwise treated prior to coating with the blended wax component and polymeric component. Furthermore, the chemical additives of the present invention are preferably soluble or dispersible in an aqueous medium, specifically within a hydraulic fracturing fluid. By “dispersible” is meant that the chemicals may dissociate from the APF particle as an aggregate of particles that are able to pass through the coating of the PW coated APF particle rather than as individual solvated molecules. This may occur, for example, if a particular chemical additive or population of chemical additives is less than extremely soluble in the aqueous-based hydraulic fracturing fluid. Thus, aggregates of the chemical agent can be liberated from the APF particle and pass through the PW coating.

### BRIEF DESCRIPTION OF THE DRAWINGS

FIG. 1 is a plot of the percentage release of ammonium persulfate over time from the particles of the present invention, in comparison to prior art particles.

FIG. 2 is a graph showing a comparison of the release over time of ammonium persulfate from a PW coated APF particle of the present invention, as compared to an otherwise substantially identical composition lacking the wax component.

### DETAILED DESCRIPTION OF THE INVENTION

In currently preferred embodiments, the chemical additives are viscosity-reducing agents or “breaker” chemicals used, for example, to decrease the viscosity of hydraulic fracturing fluids after fractures have been induced in the rock formations. Typically, a base hydraulic fracturing fluid may be prepared by hydrating a viscosity-inducing polymer such as guar, hydroxyalkyl guar, hydroxyalkyl cellulose, carboxyalkylhydroxyguar, carboxyalkylguar, cellulose or a derivatized cellulose, xanthan and the like in an aqueous fluid to which is added a suitable cross-linking agent. Cross-linking agents may include borates, zirzonates, titanares, pyroantimonies, aluminates, and the like.

The viscous fracturing fluid is thus able to carry proppants large distances within the hydraulic fracture. However, subsequent removal of the fluid (while retaining the proppant in place) to permit flow-back and extraction of gas or oil is difficult due to the viscosity of the fluid. Furthermore, the problem is exacerbated by leakage of water from the gelled fluid (“leak off”); a “filter cake” often forms in the fracture during the hydraulic fracturing process due this phenomenon. The filter cake consists of concentrated polymer, which generally possesses a very high viscosity compared to the gelled fracturing fluid. Thus, removal of filter cake from the fracture may not be accomplished easily during flow-back of a well. Adding encapsulated chemical breakers can reduce the viscosity of the filter cake by breaking the bonds of the polymer. The reduction in viscosity then leads to a more effective viscous displacement of the residual fluid from the fracture and the fracture face, while maintaining the proppant in place. This reduction in viscosity also leads to a reduction in the flow initiation gradient, which is the minimum pressure gradient across the filter cake that is needed to create a gas flow. However, it is therefore clearly essential that the chemical breakers not be released prematurely, thus preventing the suspended proppant from being carried to an optimal distance within the well.

However, the present invention is not limited to the controlled release of breaker chemical additives; indeed, any water-soluble or water-dispersible chemical additive for which a controlled rate of release is desired may be included in a PW coated APF particle of the present invention. For example, the chemical additive may comprise a scale inhibitor, a hydrate and/or halite inhibitor, a corrosion inhibitor, a biocide, a pour point suppressant, a dispersant, a demulsifier, a tracer, a drag reducer and a well clean up chemical (such as an enzyme) or an mixture of more than one of these agents. Such chemicals may be included in the PW coated APF particle of the present invention in either solid or liquid form, for example, as disclosed elsewhere in this patent application.

In a preferred use a population of the PW-coated APF particles is added above ground to a fracturing fluid. Due to the viscosity-inducing polymer, the fracturing fluid comprises a viscous or gelled polymeric solution or dispersion, a suspended proppant, the PW coated APF particles and other additives, as necessary or desired. The PW coating of the APF particles is water-insoluble, is preferably not degraded by the breaker chemical, and is permeable to a fluid component of the hydraulic fracturing fluid, and to the solubilized breaker chemical in the fracturing fluid, under the conditions of use.

Specific examples of preferred breaker chemicals of the instant invention are selected from the group consisting of ammonium and alkali persulphates, alkyl formates, salicylates, acetates, chlorites, phosphates, laurates, lactates, chloroacetates, enzymes and other solid breakers. The rate of release of the breaker chemicals from the coated solid breaker particles can be controlled by factors including: the thickness of the PW coating, the degree of cross-linking of the polymeric component (if any), the melting point of the wax component, the ratio of wax component to polymeric component, the average pore size formed by the polymeric component, the biodegradability, if any, of the polymeric component and the wax component, thickness of the PW coating layer, and the uniformity of application of the PW coating on the APF particles.

The chemical forming the core of the APF particle may be used per se when it is in the form of a solid or granule or, in another embodiment of the invention, the chemical additive may be sprayed as a solution or in a dispersed liquid form onto small, finely divided seed particles (such as urea) to form a coating on these seed particles. Essentially any solid which is of the proper size and which is inert to the breaker (or other chemical additive) may be used as the seed particle but urea is preferred. This embodiment is especially preferred where the chemical is itself a liquid, or is irregular in shape or not of the proper size.

The APF particle with or without a seed core, is coated with the PW coating.

The polymeric component of the present invention may comprise any polymeric material that is aqueous fluid permeable and is water-insoluble during its useful life under the physical and chemical conditions of hydraulic fracturing. For example, the hydraulic fracturing conditions of the present invention under the temperatures, pressures and chemical environments experienced by the PW coated APF particles of the present invention at least for a time sufficient to permit the controlled release of the chemical additive from the APF particle.

Film-forming polymers are known, and may include, for example, homopolymers, copolymers and mixtures thereof, wherein the monomer units of the polymers are preferably derived from ethylenically unsaturated monomers, for example, two different such monomers.

A particularly useful ethylenically unsaturated monomer is a compound with the formula (R₁) (R₂) (R₂)C— —OOO— —(CH═CH₂) (Compound I), wherein R₁, R₂, and R₃ are either hydrogen or saturated alkyl groups or chains. In one embodiment, R₃ of compound I is CH₃, and R₁ and R₂ of compound I have a total of about 2 to about 15 carbons; for example, such a molecule having 6 total carbons. In another embodiment, R₃ is CH₃, and R₁ and R₂ have a total of about 5 to about 10 carbons. In another embodiment, R₃ is CH₃, and R₁ and R₂ have a total of 7 carbons, i.e. R₁+R₂═C₇H₁₆.

In another embodiment, each of the R₁, R₂, and R₃ of compound I is a single chemical element. For example, the element may be a halogen, preferably a chloride. More preferably, the element may be hydrogen. Compound I having hydrogen as the element for R₁, R₂ and R₃ is known as vinylacetate.

In another embodiment, R₁ of compound I may be a single chemical element, and R₂ of compound I may be a saturated alkyl chain.

Other examples of ethylenically unsaturated monomers that may be comprised in the polymeric component of the PW coating include: monoolefinic hydrocarbons, i.e. monomers containing only carbon and hydrogen, including such materials as ethylene, ethylcellulose, propylene, 3-methylbutene-1,4-methylpentene-1, pentene-1,3,3-dimethylbutene-1,4,4-dimethylbutene-1, octene-1, decene-1, styrene and its nuclear, alpha-alkyl or aryl substituted derivatives, e.g., o-, or p-methyl, ethyl, propyl or butyl styrene, alpha-methyl, ethyl, propyl or butyl styrene; phenyl styrene, and halogenated styrenes such as alpha-chlorostyrene; monoolefinically unsaturated esters including vinyl esters, e.g., vinyl propionate, vinyl butyrate, vinyl stearate, vinyl benzoate, vinyl-p-chlorobenzoates, alkyl methacrylates, e.g., methyl, ethyl, propyl, butyl, octyl and lauryl methacrylate; alkyl crotonates, e.g., octyl; alkyl acrylates, e.g., methyl, ethyl, propyl, butyl, 2-ethylhexyl, stearyl, hydroxyethyl and tertiary butylamino acrylates, isopropenyl esters, e.g., isopropenyl acetate, isopropenyl propionate, isopropenyl butyrate and isopropenyl isobutyrate; isopropenyl halides, e.g., isopropenyl chloride; vinyl esters of halogenated acids, e.g., vinyl alpha-chloroacetate, vinyl alpha-chloropropionate and vinyl alpha-bromopropionate; allyl and methallyl compounds, e.g., allyl chloride, ally alcohol, allyl cyanide, allyl chlorocarbonate, allyl nitrate, allyl formate and allyl acetate and the corresponding methallyl compounds; esters of alkenyl alcohols, e.g., beta-ethyl allyl alcohol and beta-propyl allyl alcohol; halo-alkyl acrylates, e.g., methyl alpha-chloroacrylate, ethyl alpha-chloroacrylate, methyl alphabromoacrylate, ethyl alpha-bromoacrylate, methyl alpha-fluoroacrylate, ethyl alpha-fluoroacrylate, methyl alpha-iodoacrylate and ethyl alpha-iodoacrylate; alkyl alpha-cyanoacrylates, e.g., methyl alpha-cyanoacrylate and ethyl alpha-cyanoacrylate and maleates, e.g., monomethyl maleate, monoethyl maleate, dimethyl maleate, diethyl maleate; and fumarates, e.g., monomethyl fumarate, monoethyl fumarate, dimethyl fumarate, diethyl fumarate; and diethyl glutaconate; monoolefinically unsaturated organic nitriles including, for example, fumaronitrile, acrylonitrile, methacrylonitrile, ethacrylonitrile, 1,1-dicyanopropene-1,3-octenonitrile, crotononitrile and oleonitrile; monoolefinically unsaturated carboxylic acids including, for example, acrylic acid, methacrylic acid, crotonic acid, 3-butenoic acid, cinnamic acid, maleic, fumaric and itaconic acids, maleic anhydride and the like. Amides of these acids, such as acrylamide, are also useful. Vinyl alkyl ethers and vinyl ethers, e.g., vinyl methyl ether, vinyl ethyl ether, vinyl propyl ether, vinyl n-butyl ether, vinyl isobutyl ether, vinyl 2-ethylhexyl ether, vinyl-2-chloroethyl ether, vinyl propyl ether, vinyl n-butyl ether, vinyl isobutyl ether, vinyl-2-ethylhexyl ether, vinyl 2-chloroethyl ether, vinyl cetyl ether and the like; and vinyl sulfides, e.g., vinyl beta-chloroethyl sulfide, vinyl beta-ethoxyethyl sulfide and the like. Other useful ethylenically unsaturated monomers are styrene, methyl methacrylate, and methyl acrylate.

In a preferred embodiment, the polymeric component comprises a hydrophobic polymeric element.

Examples of preferred polymeric components include: polymers derived by copolymerizing acrylic ester monomers and ethylenically unsaturated monomers. Acrylic ester monomers include esters of acrylic acid and/or of methacrylic acid, with carbons containing from 1 to 12 carbon atoms, and preferably C₁-C₈ alkanols, such as methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate, as well as vinyl nitriles, including those containing from 3 to 12 carbon atoms, in particular acrylonitrile and methacrylonitrile.

Examples of preferred ethylenically unsaturated monomers that are polymerizable with the above monomers are vinyl esters of carboxylic acids, for instance vinyl acetate, vinyl versatate or vinyl propionate. In a preferred embodiment these may be incorporated at up to 40% by weight of the total weight of the copolymer.

Other polymers that may be used in the polymer component of the present invention are mixtures of alkyl acrylates and styrene acrylate; vinyl acrylic latex polymers containing about 0% to about 60% (weight) monovinyl aromatic content such as styrene, and from about 15% to about 95% (weight) alkyl acrylate or methacrylate ester. The alkyl acrylate or methacrylate ester can comprise, for example, ethyl butyl or 2-ethylhexylacrylate, methyl, butyl or isobutyl methacrylate or mixtures thereof. Vinyl acrylic latex polymers of the type described above are commercially available from, for example, Rohm and Haas Company, Philadelphia, Pa. or S.C. Johnson Wax, Racine, Wis.

In other embodiments, the polymeric component of the PW coating may comprise polymers including units from vinyl acetate, ethylene and vinyl chloride, and combinations thereof, that is, combinations of such polymers. In another embodiment, the polymeric component may be selected from polymers including units from vinyl acetate; an acrylate ester including, for example, lower alkyl, for example, alkyl having from 1 to about 6 carbon atoms, acrylate and methacrylate esters, such as butyl acrylate, butyl methacrylate and the like; and at least one monomer selected from vinyl neopentanoate, vinyl neohexanoate, vinyl neoheptanoate, vinyl neooctanoate, vinyl neononanoate and vinyl neoundecanoate. Combinations of such polymers can be employed and are included within the scope of the present invention. Such polymeric components including units selected from one of vinyl neononanoate, vinyl undecanoate and vinyl neopentanoate may be employed.

Combinations of the polymeric components disclosed in the immediately preceding two paragraphs can be included in the same coating, and such embodiments are included within the scope of the present invention.

While in a preferred embodiment a separate cross-linking reagent is not part of or comprised as part of a polymeric component or the PW coated APF particle, in other embodiments a separate cross-linking reagent may be used to provide cross-linking of the polymer chains. The addition of a separate cross-linking reagent in combination with an appropriately reactive polymer often results in smaller pores and a resulting lower release rate, depending in part on the concentration of the cross-linking reagent and the degree of polymerization that is permitted to occur. Examples of a suitable cross-linking reagent may include, without limitation, an aziridine pre-polymer (for example, pentaerythritol-tris-[β-(aziridinyl)priopionate] or a carbodiimine(for example, 1,3-dicyclohexyldicarbodiimide). When used, the cross-linking agent may be admixed with, for example, an acrylic polymer in an amount of from about 0.5% to about 10% by weight of total solids present. For example, the cross-linking agent may be present in an amount of from about 2.5% to about 3.5% by weight of total coating solids.

A particularly preferred polymeric component comprises an acrylic copolymer containing branched vinyl ester monomers, wherein at least one of the branched vinyl ester monomers is a vinyl versatate monomer. In a particularly preferred embodiment the polymeric component initially comprises a liquid dispersion of the copolymer in water (a colloidal dispersion of polymer microparticles in an aqueous medium is referred to as a latex), wherein the acrylic/vinyl versatate copolymer particles (about 0.07 microns in size) are present at between 40% and 50% by weight and water between 50 and 60% by weight. Arkema, Inc., King of Prussia, Pa., sells a preparation of such a polymer under the name NeoCAR™. This preparation has a viscosity of about 150 cP (centipoise) and a pH of about 8.5, about 45% by weight of solids, and has a glass transition temperature (Tg) midpoint of 50° C. and a minimum filming temperature (MFT) of about 45° C., and is characterized as a hydrophobic latex exhibiting ambient cross-linking; the preparation is not mixed with a separate cross-linking reagent before use.

The wax component may comprise natural and/or synthetic waxes or a blend of such waxes. By “wax” is meant an organic, water insoluble hydrophobic compound or class of compounds that is/are plastic (malleable) near room temperature (about 70° F. to about 75° F.); generally, waxes melt above 100° F. and form liquids of low viscosity. Natural waxes include waxes such as beeswax, cines wax, shellac wax, Carnauba wax, montan wax (extracted from lignite and brown coal) and paraffin wax (from petroleum). Synthetic waxes include polyethylene wax, substituted amide waxes, polymereized α-olefines, polypropylene wax and tetrafluoroethylene wax (PTFE). Polypropylene wax is generally polymerized from propylene and then either maleated or oxidized to give chemical functionality so that it is more easily emulsified. Polypropylenes are hard materials with molecular weights from 10,000-60,000+ and high melting points from 248° F.-320° F.

In a preferred embodiment, the wax component of the present invention is a mixture or blend of more than one wax, with a first wax having a higher melting point before blending than a second wax. In a preferred embodiment the wax component of the PW coating may comprise a paraffin wax and/or a polyethylene wax, or a mixture of these. A particularly preferred wax component comprises a blend of paraffin and polyethylene waxes.

Paraffin waxes are generally mixtures of alkanes (e.g., CH₃—CH₂₍ₙ₎—CH₃ and/or, less commonly, branched versions of these alkanes) that fall within the 20≦n≦40 range. Paraffin waxes are a by-product of petroleum refining; they are found in the solid state at room temperature and begin to enter the liquid phase past approximately 37° C. (about 100° F.). Commercially available emulsions of paraffin wax generally comprise from about 40% to about 60% solids by weight.

Polyethylene waxes are synthetic waxes. Polyethylene waxes are manufactured from ethylene, which is generally produced from natural gas. The polyethylene may be oxidized or co-polymerized with acrylic acid to give the polyethylene chemical functionality, which allows it to be emulsified. Polyethylene is classified as either high-density polyethylene (HDPE) or low-density polyethylene (LDPE). HDPE is higher melting (230° F.-284° F.) and is harder. LDPE is lower melting (212° F.-230° F.) and softer. Preferably, the polyethylene wax used in the wax component of the PW coating of the present invention has a melting temperature of up to about 224° F. Commercially available emulsions of paraffin wax generally comprise from about 24% to about 40% solids by weight.

Mixtures or blends of waxes having different melting temperatures will generally have an melting temperature intermediate between the melting points of the waxes having the highest and lowest melting temperatures.

Preferably, the wax component has a melting point greater than about 100° F., or greater than about 120° F., or greater than about 130° F., or greater than about 135° F., or greater than about 140° F., or greater than about 145° F., or greater than about 150° F., or greater than about 155° F., or greater than about 160° F., or greater than about 165° F., or greater than about 170° F., or greater than about 180°, or greater than about 190° F., or greater than about 200° F., or greater than about 210° F., or more. Those of ordinary skill recognize that the wax component may have a melting point that falls within a range from about 100° F. to about 215° F. or more, or any subrange of this range (100° F. to about 215° F.) comprising temperature integers falling within this range, and that this specification specifically describes each and every such subrange. Similarly, any range of values provided in this specification will be understood to include a specific disclosure of each and every sub range, as expressed in natural numbers, contained between the high and low values of the broadest range.

The wax component of the present invention may be charged (cationic or anionic) or uncharged in aqueous dispersion or emulsion, or in mixture with the polymeric component. Preferably, the wax component is anionic.

In a particularly preferred embodiment, the wax component comprises a commercially available emulsion comprising a blend of a paraffin wax and a polyethylene wax bearing the trade name Michem® Lube 270R and sold by Michelman company.

Preferably, a water-miscible solvent suitable for use as a coalescent is also used in preparing the coating emulsion. For example, the glycol ether Butyl Carbitol™ (diethylene glycol butyl ether) is currently a preferred solvent in the PW coating emulsion of the present invention. However, those of ordinary skill in the art will recognize that other coalescing solvents may be used in the PW coatings of the present invention, such as (without limitation): ethylene glycol monobutyl ether and/or other alkyl ethers of ethylene gylcol, such as those commonly used in paints; acetates of glycol; and 2,2,4-tromethyl-1,3-pentanediol monoisobutyrate; liquid esters (e.g., those produced by the reaction of isobutyl alcohol with a dibasic acid, and mixtures thereof; and other coalescing solvents.

While not wishing to be limited by theory, Applicants currently believe that the PW coatings of the present invention more accurately control the diffision of an aqueous fluid into the coated APF particle and the rate of the solubilized chemical additive through the coating of the particle to the hydraulic fracturing fluid and/or filter cake than in a coated APF particle lacking the wax component of the PW coating.

Depending upon the temperature of the rock formation to be treated in the hydraulic fracturing activity, and the desired time for the fracturing fluid to break the rock formation, the PW coated APF particle may be present in an amount from about 0.1 to about 50 pounds per thousand gallons of fracturing fluid, or more. In addition, the coated APF particles of the present invention may also be used in a fracturing fluid along with uncoated chemicals, including chemicals of the same general type. When used with uncoated chemicals in the same general type, the activity of the coated chemical additives may be extended over a period of time so that a certain amount of activity is present when the hydraulic fracturing fluid is prepared, and further activity is released from the coated particles later in time, or with a rise in temperature or a change on the local chemistry underground.

In certain embodiments the PW coated APF particles of the present invention may be introduced into the well either before or after the hydraulic fracturing fluid. For example if the chemical additives are “clean-up” chemicals, such as enzymes, they may be introduced after the dense fracturing fluid has been removed.

PW coated APF particles having different release rates may be made and used in the hydraulic fracturing operation, for example, by varying the polymeric component of the PW coating, by adjusting the concentration of the wax component, or by adding or adjusting the concentration of a cross-linking agent to delay and then extend the release of oilfield chemicals within the underground fracture or formation.

The PW coatings of the present invention modulate the permeability of the polymeric component to more finely control the release of the chemical additive within the particle than would be the case without the wax component. While not wishing to be limited by theory, Applicants presently believed that the hydrophobic wax component of the PW coating lessens the permeability of the coating of a PW-coated APF particle to an aqueous-based fluid compared to the release rate of the same additive component in a coated APF particle having an otherwise identical polymeric component (P) coating. That is, the otherwise identical P coated APF particle will be more water-permeable without the wax component than will the PW coated APF particle. By “otherwise identical” is meant that the P coated APF particle has a coating in which only the same polymeric component (P) is used as a coating, wherein the polymeric component has the same porosity and permeability (including the same degree of cross-linking, if any; same coating efficiency on the particle, same polymeric component and the same method of preparation and particle coating), and where the release rate of the APF is determined under substantially identical conditions (temperature, liquid medium, pressure, etc) as for the PW coated APF particle.

Preferably (although not necessarily invariably) the polymeric component is not cross-linked using a separate cross-linking reagent. However the polymeric component, for example, in a latex (a stable aqueous suspension of polymer microparticles), may already contain internal cross linking prior to being formulated in the PW coating. Furthermore, some additional internal cross-linking may occur after formulation in the coating component, or during the coating process.

Although Applicants are not entirely certain why this is the case, it is believed that the wax component, particularly a wax component having a melting temperature slightly above the temperature at which the hydraulic fracturing operations are conducted, may block a plurality of pores in the polymeric component when it is blended therewith, thus reducing the “release area” of the coating of the particle. Alternatively, or additionally, the wax component, being water-impermeable and highly hydrophobic, may cause water and other polar components to be partly excluded from the interior of the PW coated APF particle of the aqueous fluid by actually repelling water molecules from the surface, or portions of the surface, of the particle to a significant extent thus slowing the release rate of the APF from the particle.

In the present invention, one or more chemical additives are incorporated into APF particles in which the chemical additive is encapsulated by a PW coating. In a preferred embodiment the particles are delivered into a subterranean reservoir and are structured to prevent or delay substantial release of the chemical until they have arrived in the reservoir.

Thus, in one aspect the present invention provides a process for hydraulic fracturing of a subterranean reservoir formation accessible by a wellbore, comprising pumping an aqueous suspension of PW coated APF particles, wherein the particles comprise comprising an oilfield chemical contained within an encapsulating coating comprising a water-insoluble polymeric component and a water-insoluble wax component coating components from the surface via the wellbore and into the reservoir, wherein the PW-coated APF particles are structured to prevent or delay substantial release of the chemical until the particles have arrived in the reservoir. Although the term ‘oilfield’ is used for convenience, the hydrocarbon in the reservoir may be oil, gas or both.

Generally the process for hydraulic fracturing will include pumping a hydraulic fracturing fluid from the surface via the wellbore and into the reservoir so as to open a fracture of the reservoir formation, and subsequently allowing fluid flow back from the fracture to the wellbore and hence to the surface. Producing hydrocarbon from the reservoir via the fracture and the wellbore will follow this step.

The aqueous suspension of particles which is pumped into the well bore may be a fluid which is distinct from the hydraulic fracturing fluids, but in many instances it will be convenient for it to be a suspension of the particles in a quantity of the hydraulic fracturing fluid.

Preferably the PW coated APF particles are structured so that the rate of chemical release is such that at least 75% and more preferably at least 90% of the oilfield chemical may be retained within the particles until after they enter the subterranean fracture. The combination of a wax component with the polymeric component permits the design of a particle that is structured to have a slower release rate than would an otherwise identical, or substantially identical particle having a coating comprising only the polymeric component.

The relative dimensions and quantities may be such that the amount of oilfield chemical encapsulated within a particle is between 1 and 90 wt % of the overall particle, possibly between 1 and 80 wt %. The median size of the overall particles may lie between about 50 microns and 5000 microns or more; those of ordinary skill in the art will recognize that or about 100 microns and about 3000 microns, or about 200 microns, or about 300 microns, or about 500 microns or about 750 microns and about 2000 microns. In a particularly preferred embodiment, the PW coated coated APF particles have a mean diameter (or longest dimension) of from about 50 microns to about 5000 microns, or any subrange of this range comprising micron integers of length falling within this range, and that this specification specifically describes each and every such subrange.

Release of the oilfield chemical from the PW coated APF particle may be brought about or facilitated in a number of ways. One possibility is by exposure to the reservoir temperature. The PW coating, including the percentage and melting point of the wax component's constituents, may therefore be chosen so as to liberate the oilfield chemical from the particles into surrounding fluid at a rate which increases with temperature, such that oilfield chemical is liberated from the particles after they have entered the fracture. Reservoir temperatures are generally higher than ambient temperatures at the surface. A high percentage of all fracturing jobs take place with reservoir temperatures in a range from 70° F. to 212° F. or more.

Response to temperature can thus provide a very effective parameter for the design of PW coatings to permit the release of the chemical agent from the APF particle at a greater rate when the temperature of the desired reservoir formation(s) is/are encountered and the particles enter the formation and become heated to the reservoir temperature.

Utilizing the temperature of the reservoir to cause or accelerate the release of the chemical is also beneficial in the context of fracturing when a large volume of aqueous fracturing fluid is pumped into the reservoir and for the most part does not mixed with formation fluid previously present. An increase in temperature towards the natural temperature of the reservoir happens inevitably, even though there is little or no mixing with the formation fluid. It is possible to avoid the inconvenience and cost of pumping in an additional fluid merely to induce some other change (for example a change in pH).

While this invention is further described below with respect to various specific examples and embodiments, it is to be understood that the invention is not limited thereto and that it can be variously practiced consistent with the scope of the following claims. For example, any feature disclosed herein may be combined with any other component or feature and will be deemed to fall with the description of this patent application.

### EXAMPLES

### Example 1

A PW coated APF (where the additive chemical is ammonium persulfate) particle (Sample A) according to the present invention is made as follows: a breaker chemical additive comprises 500 grams of ammonium persulfate particles having a size distribution wherein 42% of the particles have a diameter (or longest dimension) greater than 850 microns, and 58% of the particles have a diameter (or longest dimension) greater than 424 microns. The particles are placed within a bottom spray Wurster coating fluidized bed apparatus (Magna Coater Fluid Bed system, Model 0002 having a 6.7 liter capacity) for coating. Ammonium persulfate is solid and stable at temperatures below about 212° F.

A coating spray solution is made as follows: a polymer component pre-formulation is first made by combining and thoroughly mixing NeoCAR® 850 with butyl carbitol and water at the weight ratio of 91.7 to 4.2 to 4.1, respectively. This polymer component is then combined and mixed with 1.2% Michem™ Lube to make a 100% emulsion.

450 grams of the resulting PW coating spray is then loaded into the spray reservoir of the bottom spray Wurster coating device. The coating chamber, which is cylindrical in shape, is concentric to and approximately half the diameter of the outer chamber. The bottom of the device is a perforated plate containing larger holes under the inner (coating) tube. The liquid spray nozzle is located in the center of the base, and is position to permit the circulation of particles from the outside annular space to the high velocity airstream within the coating chamber. The ammonium persulfate particles move upwards in the center, where coating and efficient drying and water vapor/solvent removal occur. At the top of the coating chamber the particles discharge into an expansion area and then flow down as a gas/solid suspension into the annular space surrounding the center coating chamber.

The coating mixture is applied using an atomizing nozzle at a temperature of 25° C., an atomizing air pressure of 25 psi, and an airflow of 25 SCFM at a spray flow rate of about 8 g/min. After the coating is applied to an average of about 25% of the weight of particles, the finished encapsulated ammonium persulfate has a temperature of 15° C.

A quantity of prior art coated ammonium persulfate breaker particle is obtained for comparison purposes; the particles are sold under the name Gel Breaker 710E by Frac-Chem company of Lafayette, La. The Gel Breaker particles are listed in the product data sheet as having a off white granular appearance with a faint organic odor, a specific gravity of 1.72, and a bulk density of 56 to 64 lb/ft³, and are said to be useful for hydraulic fracturing applications having an actual fluid temperature of from about 130° F. to about 200° F. The Material Safety Data Sheet for Gel Breaker 710E (dated Apr. 27, 2011) states that the particles comprise greater than 75% (w) ammonium persulfate, greater than 16% (w) cured acrylic resin, and less than 10% (w) of crystalline silica (quartz), and a 1% suspension in water has a pH in water of 4.5 to about 5.5.

While the exact composition of the Gel Breaker 710E particles remain a trade secret, these particles are thought to be made of materials, and using methods, similar to those disclosed in Example 1 of U.S. Pat. No. 5,373,901, hereby incorporated herein by reference in its entirety. In this patent encapsulated ammonium persulfate particles are made as follows. About 1000 grams of 20-50 mesh (U.S. Sieve Series) ammonium persulfate obtained from FMC Corporation are placed in a Versaglatt GPCG I fluidized bed apparatus. The Versaglatt unit is set up to provide top spray by insertion of a top spray insert and a three micron filter bag is utilized. The spray nozzle is placed in the lower position on the top spray insert. A 1.2 mm nozzle is utilized. The coating material is applied at a coating agent temperature of 35° C., an atomizing air pressure of 2.0 bar, an air rate of 3-4 m/sec. and a spray flow rate of 15 ml/min. After the coating agent is applied, the encapsulated material is heated to a temperature of about 42° C. for a period of about 10 minutes and then cooled to room temperature.

The competitive coating agent is prepared by adding 182 grams of water to 790 grams of a partially hydrolyzed acrylate/silica mixture. The acrylate/silica mixture contains 26.8% of approximately 1 micron diameter-sized silica particles, by weight, and 28.4% acrylate resin. Thereafter, 28 grams of a crosslinker comprising an aziridine prepolymer, present as a 50% solution, is added to the mixture and the coating is then applied by spraying. Using the above formulation, an encapsulated product is produced having a coating comprising 31%, by weight, of the weight of the particles.

While the above method results in an embodiment of the encapsulated ammonium persulfate particles disclosed in the '901 patent disclosure that appears to have having a larger silica content and coating percentage by weight than is indicated by the Material Data Sheet of the Gel Breaker 710E particles, the composition of each of the encapsulated particle types appears to fall within the disclosure of the U.S. Pat. No. 5,373,901.

### Example 2

A 100 lb batch preparation of PW coated APF particles according to the present invention is made as follows:

A preparation of a PW coating composition is made by combining 3.70 lb of deionized water, 4.0 lb of glycol ether DB (diethylene gycol monobutyl ether), 86.05 lb of Neocar® 850, 5.0 lbs of Michem™ 270R wax emulsion, and 1.25 lb of polyfunctional aziridine PZ-28 (trimethylolpropane tris(2-methyl-1-aziridine propionate) to form a solution. This PW coating composition is loaded into the spray reservoir of the bottom spray Wurster coating device.

The ammonium persulfate particles (70 lb) are preferably between about 4 and about 100 mesh, more preferably between about 4 and about 50 mesh, more preferably between about 10 and about 50 mesh, even more preferably between about 20 and about 40 mesh.

79.24 lbs of the liquid net weight of the PW coating composition is loaded into the spray reservoir of the bottom spray Wurster coating device and used to coat 70 lbs of sifted ammonium persulfate particles. The coating is applied under the following conditions.

| Inlet flow rate: | 500-800 SCFM (depending upon the | |
|---|---|---|
| | batch weight and filter cleanliness | |
| | as the run progresses) | |
| Temperature: | 50° at the beginning of the run; 30° | |
| | at the end of the run to dry and | |
| | cool the breaker particles. | |
| Coating spray | 30 | psi |
| pressure: | | |
| Coating spray | 0.8-1.5 | lbs per minute |
| rate: | | |
| Shuttle opening: | 6-18% | |
| Partition Height: | 1-1.5 | inches |
| Nozzle tip: | 1.5 | mm |

When the coating composition has been sprayed onto the particles at the desired weight percentage (30% in this embodiment), the coated particles are permitted to dry and then solid magnesium stearate (1.0 lb) is introduced as a non-stick agent to the chamber of the coating device while the bed is still fluid to coat the particles, preventing them from sticking together after the fluidizer is turned off and the particles are packaged.

### Example 3

A comparison is made between the rate of ammonium persulfate release by the PW coated APF ammonium persulfate particles of the present invention (Sample A) and the competitive Gel Breaker 710E particles, purchased from Frack-Chem company (Sample B).

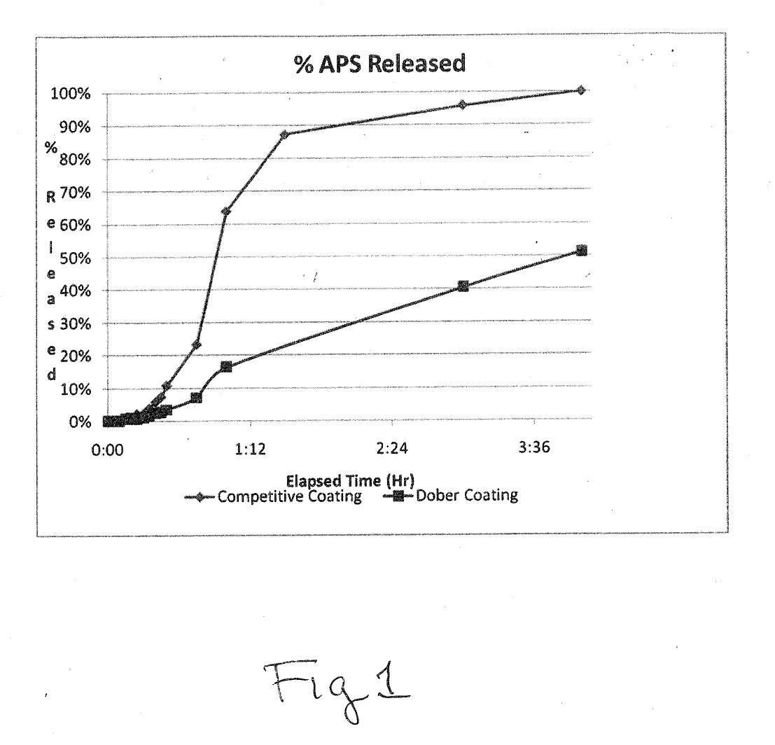

Each particle preparation were individually assayed for ammonium persulfate release as follows: 1.5 grams of the particle preparation was added to 1 liter of deionized water which had been heated to 170° F. with gentle stirring. Aliquots of 10 mL of each Sample A and Sample B were withdrawn at the time intervals on the x-axis of FIG. 1, and were then analyzed using a Hach sulfate test (Hach PO Box 389, Loveland Colo. 80539) using a DR2800 spectrophotometer. Persulfate decomposes at 170° F. to sulfate ion, which then reacts with BaCl₂ (in the Hach sulphate test kit) to form BaSO₄, which forms a cloudy precipitate, and can be measured turbidometrically. Thus, the release of ammonium persulfate can be measured by the increase in sulfate ion formed in the solution.

Following the addition of the sulphate test reagents, the turbidity of each aliquot was measured by spectrophotometer, and the results were plotted as the percentage of ammonium persulfate released over time. The release profile is set forth below in FIG. 1.

### Example 4

PW-coated APF particles (Sample 1) coated as disclosed in Example 1 are dried and collected. These particles are used as a component in an aqueous hydraulic fracturing fluid for injection into oil- or gas-containing rock formations underground. 500 g of the PW coated APF particles are suspended with the proppant and gelling agents (comprising guar and guar gum derivatives) and remainder of the hydraulic fracturing fluid immediately prior to injection into deep shale gas formations to facilitate the retrieval of natural gas. The fluid is injected into the wellbore of the well at high pressure and permitted to penetrate perforations in the wellbore into the desire reservoir formations at a pressure sufficient to fracture the rock, and deliver the proppants to the fracture zone. The fluid containing the pproppants, gelling agents and ammonium persulfate (APS) in the PW coated APF particles are permitted to remain within the formation for a period of time sufficient to permit the APS to be released therefrom, thereby decreasing the viscosity of the fluid and/or filter cakes containing the viscosity increasing components of the fluid. After a period of time sufficient to reduce the viscosity of the fluid, the water pressure is then reduced and fluid removed from the well, thereby leaving the proppant in place and permitting gas or oil to flow.

It will also be apparent that it may be advantageous under certain circumstances for more than one population of PW coated APS particles to be formulated with a different wax component in the PW coating; for example, a coating having a different mixture of waxes in the wax component, a different ratio of the wax component to polymeric component in the PW coating, the use of waxes having greater or lesser melting points than those used with different PW coated APS particles, and the like. In this way, something of a staggered release can be achieved depending upon the temperature of the aqueous medium (e.g., the depth of the fluid within a well.)

### Example 5

An experiment is made comparing the rate of ammonium persulfate release by the PW coated APF ammonium persulfate particles of the present invention (Sample A) and an otherwise substantially identical particle lacking the wax component [Sample C]. Particles were made as described in Example 1, with the coating solution lacking the wax component for Sample C.

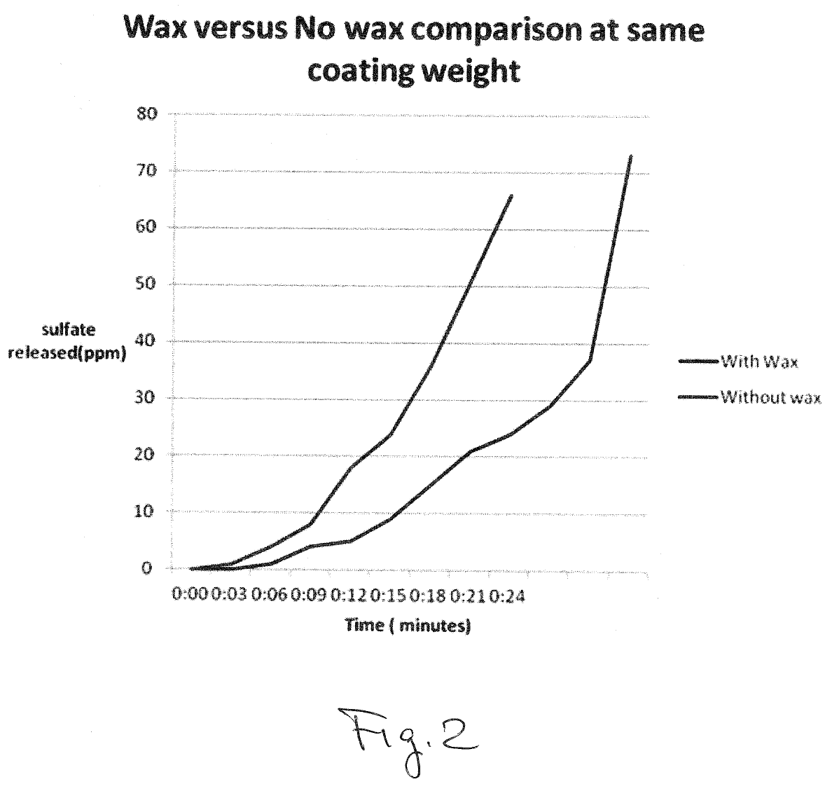

Each particle preparation were individually assayed for ammonium persulfate release as follows: 1.5 grams of the particle preparation was added to 1 liter of deionized water which had been heated to 170° F. with gentle stirring. Aliquots of 10 mL of each Sample A and Sample C were withdrawn at the time intervals on the x-axis of FIG. 2, and were then analyzed using a Hach sulfate test (Hach PO Box 389, Loveland Colo. 80539) using a DR2800 spectrophotometer. As before, the release of ammonium persulfate can be measured by the increase in sulfate ion formed in the solution.

Following the addition of the sulphate test reagents, the turbidity of each aliquot was measured by spectrophotometer, and the results were plotted as the percentage of ammonium persulfate released over time. The release profile is set forth below in FIG. 2; the wax component of Sample A delays the release of APS relative to Sample C.

While this invention has been described with respect to various specific examples and embodiments, it is to be understood that the invention is not limited thereto and that it can be variously practiced within the scope of the following claims. For example, any feature disclosed herein may be combined with any other component or feature and will be deemed to fall with the description of this patent application.

Each and every publication, patent and published patent application cited herein is individually incorporated by reference in its entirety as part of the specification of this application.

1. A composition comprising a population of coated particles comprising a chemical additive component useful in oil and gas extraction comprising:
a particulate active component comprising said chemical additive component selected from the group consisting of a scale inhibitor composition, a hydrate and or halite inhibitor composition, a pour point suppressant composition, a dispersant, a demulsifier, a tracer, a drag reducer, a viscosity-reducing composition, an oxidizer composition, a pH modulating composition, a lubricant composition, a cross-linking composition, an anti-corrosion composition, an biocide composition, a crosslink-enhancing composition, and a combination of two or more of these compositions, and
a water insoluble coating encapsulating the particulate active component comprising a combination of a polymeric component and a wax component;
wherein the coated pellet is formulated to release the chemical additive component in an aqueous fluid having a temperature of between about 90° F. and 212° F. at a slower rate than an otherwise identical coated pellet comprising the polymeric component but lacking the wax component under identical conditions.

2) The coated pellet of claim 1 wherein the polymeric component comprises a latex component.

3) The coated pellet of claim 2 wherein the ingredients of the particulate active component are substantially homogeneously distributed.

4) The coated pellet of claim 1 in which the particulate active component continue to release the chemical additive component into an aqueous environment after 3 hours' immersion in an aqueous solvent at 170° F.

5) The coated pellet of claim 1 wherein the particulate active component comprises an anti-scale composition.

6) The coated pellet of claim 1 wherein the particulate active component comprises a pH modulator composition.

7) The coated pellet of claim 1 wherein the particulate active component comprises an anti-corrosion composition.

8) The coated pellet of claim 1 wherein the particulate active component comprises a biocide composition.

9) The coated pellet of claim 1 wherein the particulate active component comprises a breaker composition.

10) The coated pellet of claim 1 in a shape selected from the group consisting of a sphere, an ovoid shape, an irregular shape, a flattened sphere, a flattened ovoid shape, a cylinder, or a polyhedron.

11) The coated pellet of claim 1 wherein the particulate additive component comprises a crystalline solid.

12) The coated pellet of claim 1 wherein the particulate active component comprises a compressed powder.

13) A method of making a coated chemical additive composition in particulate form, comprising:
forming a water-soluble or water-dispersible particulate active component comprising a water treatment formulation selected from the group consisting of a scale inhibitor composition, a hydrate and or halite inhibitor composition, a pour point suppressant composition, a dispersant, a demulsifier, a tracer, a drag reducer, a viscosity-reducing composition, an oxidizer composition, a pH modulating composition, a lubricant composition, a cross-linking composition, an anti-corrosion composition, an biocide composition, a crosslink-enhancing composition, and a combination of two or more of these compositions;
preparing a coating composition comprising a polymeric component, a wax component and a solvent (“PW coating”) at a concentration sufficient to coat the outer surface of the particulate active component when applied thereto;
coating the outer surface of the particulate active component with the PW coating;
evaporating the solvent from the wet PW coating the particulate active component to form a chemical additive composition in particulate form.

14) The method of claim 13 wherein the forming step comprises compressing a powder in a shaping die.

15) The method of claim 13 wherein the formed particulate active component is substantially homogenous.

16) The method of claim 13 wherein the formed particulate active component has a shape selected from the group consisting of a sphere, an irregular shape, an ovoid shape, a flattened sphere, a flattened ovoid shape, a cylinder, or a polyhedron.

17) The method of claim 13 wherein the solvent comprises a water-miscible solvent.

18) The method of claim 19 wherein the solvent comprises a glycol ether.

19) The method of claim 13 wherein the PW coating composition comprises an acrylic/vinyl versitate copolymer.

20) The method of claims 13 and 20 wherein the wax component comprises a wax selected from the group consisting of a paraffin wax, a polyethylene wax, and a combination of these waxes.

21) The method of claim 15 wherein the coating step comprises spraying the particulate additive component with the PW coating composition.

22) The method of claim 15 wherein the formed particulate additive component is agitated in a fluidized bed while being sprayed with the PW coating composition.

23) The method of claim 15 wherein the evaporating step is aided by providing an inlet air flow carrying air to the coated pellet and an outlet air flow carrying air from the coated pellet.

24) A process for facilitating hydrocarbon extraction from hydraulically fractured rock within a subterranean gas or oil reservoir formation accessible by a wellbore, comprising:
providing an aqueous fluid comprising a suspended chemical additive in particulate form (“APF particle”) selected from the group consisting of a scale inhibitor composition, a hydrate and or halite inhibitor composition, a pour point suppressant composition, a dispersant, a demulsifier, a tracer, a drag reducer, a viscosity-reducing composition, an oxidizer composition, a pH modulating composition, a lubricant composition, a cross-linking composition, an anti-corrosion composition, an biocide composition, a crosslink-enhancing composition, and a combination of two or more of these compositions, coated with a water insoluble PW coating comprising a polymeric component and a wax component,
pumping said suspension into the wellbore of an oil or gas well,
ceasing flow of the aqueous suspension for a period of time sufficient to permit the release of the chemical additive into the fluid at a desired position within the oil or gas well, wherein the PW-coated APF particles are structured to prevent or delay substantial release of the chemical until the particles have arrived at said desired position,
pumping the fluid from the well, and
collecting the oil or gas from the wellbore.

25) An additive composition comprising:
a core comprising a chemical additive component effective when released in a hydraulic fracturing operation to provide a desired result; and
a coating substantially surrounding the core and comprising a combination of a polymeric component and a wax component; wherein the additive composition is formulated, when placed in an aqueous fluid composition at a constant temperature in a range of about 90° F. to about 212° F. to release the additive component into the aqueous fluid composition at a more constant rate over time relative to an otherwise substantially identical additive composition lacking the wax component.
